(19) United States
(12) Patent Application Publication
(10) Pub. No.: US 2008/0147905 A1
(43) Pub. Date: Jun. 19, 2008

(54) Method and system for generating a DMA controller interrupt

(75) Inventors: Jiaxiang Shi, Singapore (SG); Ingo Volkening, Singapore (SG); Bingtao Xu, Singapore (SG)

Correspondence Address: Davidson, Davidson & Kappel, LLC, 485 7th Avenue, 14th Floor, New York, NY, 10018, US

(73) Assignee: Infineon Technologies AG, Muenchen (DE)

(21) Appl. No.: 11/639,968

(22) Filed: Dec. 15, 2006

(51) Int. Cl. G06F 13/28; G06F 13/24

(52) U.S. Cl. 710/22; 710/260

(57) ABSTRACT

In a first exemplary embodiment of the present invention, a computer system comprises a CPU, and a DMA controller coupled to the CPU for data transfer via a data transfer interrupt mechanism. According to a feature of the present invention, an interrupt coalescing unit couples the DMA controller to the CPU for aggregation of data transfer interrupts generated by the DMA controller, and transfer of data corresponding to the aggregated interrupts, between the CPU and the DMA controller, as a single interrupt.

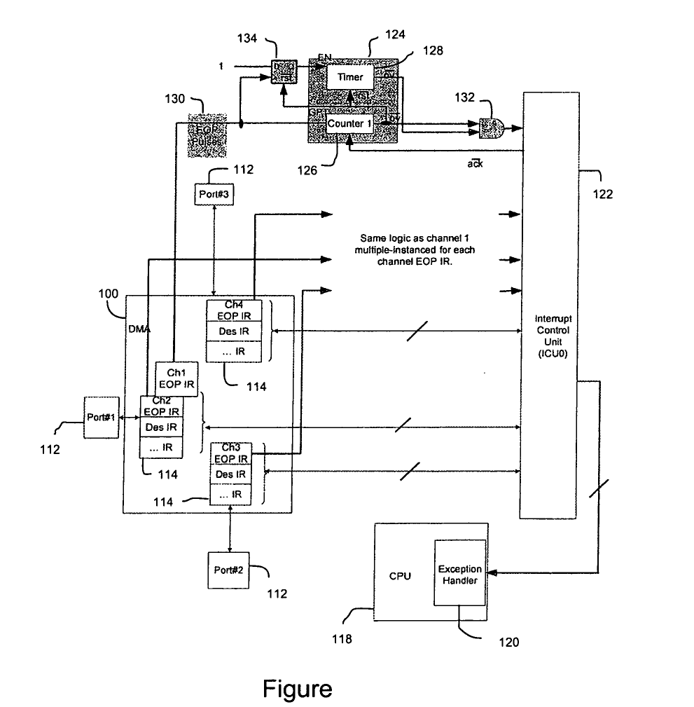

### BACKGROUND OF THE INVENTION

A CPU in, for example, a microprocessor, executes instructions in a predetermined sequence, typically as a function of a computer program. Moreover, the CPU is coupled to various peripheral devices that interact with the CPU to perform certain functions, such as, for example, servicing the input of data from an external source, to the main memory of the microprocessor. When a peripheral device requires service of a memory request by the CPU, it is necessary for the CPU to execute a specific set of instructions to provide the service. Requests by peripheral devices are often asynchronous to the execution of the computer program currently running on the CPU.

An interrupt is a mechanism used to suspend normal execution of a current computer program, so that the CPU can process an asynchronous request by a peripheral device. After the interrupt has been serviced, the CPU returns to normal program execution. An interrupt service routine is a program that executes upon input of an interrupt to the CPU, to implement the interrupt. Execution of the interrupt service routine utilizes microprocessor cycles, and, thus, adds overhead to processing time.

A direct memory access (DMA) controller is utilized as an interface between a CPU and peripheral devices. A DMA controller may include several ports for coupling to various peripheral devices, and is arranged to couple the ports to an interrupt control unit. The interrupt control unit is, in turn, coupled to an exception handler unit of the CPU. The exception handler unit processes interrupt requests input to the CPU. Communications between the peripheral devices, DMA controller and CPU are executed pursuant to standard communication protocols that provide for defined data packets for transmission between components.

In known DMA controller operation, the DMA controller generates one interrupt for each packet it receives from a peripheral device. Modern, high performance communication systems provide high speed data transfers resulting in a very high packet processing rate. Accordingly, an interrupt rate based upon a single packet per interrupt, is also high. As each interrupt is overhead imposed on microprocessor operation, resulting in a slowing down of overall processing time, a high interrupt rate can cause unacceptably low processor utilization efficiency.

### BRIEF DESCRIPTION OF THE DRAWINGS

FIGURE is a block diagram of a DMA interrupt generation mechanism according to a feature of the present invention.

### DETAILED DESCRIPTION OF EMBODIMENTS

In one exemplary embodiment of the present invention, a computer system comprises a CPU, and a DMA controller coupled to the CPU for data transfer via a data transfer interrupt mechanism. According to a feature of the present invention, an interrupt coalescing unit couples the DMA controller to the CPU for aggregation of data transfer interrupts generated by the DMA controller, and transfer of data corresponding to the aggregated interrupts, between the CPU and the DMA controller, as a single interrupt.

In a further exemplary embodiment of the present invention, a method for transferring data between a DMA controller and a CPU comprises the steps of aggregating data transfer interrupts generated by the DMA controller; and controlling a transfer of data corresponding to the aggregated interrupts, between the CPU and the DMA controller, as a single interrupt.

In a further exemplary embodiment of the present invention, an interrupt coalescing unit is provided for use in a computer system comprising a DMA controller coupled to a CPU. According to a feature of the present invention, the interrupt coalescing unit is arranged and configured to couple the DMA controller to the CPU for aggregation of data transfer interrupts generated by the DMA controller, and transfer of data corresponding to the aggregated interrupts, between the CPU and the DMA controller, as a single interrupt.

The FIGURE illustrates a block diagram of a DMA interrupt generation mechanism according to an exemplary embodiment of the present invention. Interrupt generation units 114 of a DMA controller 100, each with an EOP (end of packet) interrupt and a DES (descriptor related) interrupt, are coupled to an interrupt control unit 122. The interrupt control unit 122 is, in turn, coupled to an exception handler 120 of a CPU 118. A DMA controller as used herein may be any device which is able to perform a storage access on a memory device or a peripheral device without interrupting the CPU. The interrupt generation units 114 are each coupled to a respective port 112 to provide coupling to a peripheral device. Each interrupt generation unit 114 generates a data transfer interrupt for transmission to the interrupt control unit 122 upon input of a data packet containing data to be transferred from the peripheral device, such as a PPE (protocol process engine) or DEU (data encryption standard execution unit). An interrupt coalescing unit 124 may be arranged according to one embodiment of the present invention between the interrupt generation unit 114 of a port 112 and the interrupt control unit 122. Interrupt coalescing is a technique that has been utilized in a software or gigabit NIC implementation.

In interrupt coalescing, interrupt requests are aggregated until a preselected number of interrupt requests have been asserted. At that time, a single interrupt is input to the CPU 118, and all data of all of the data packets corresponding to the aggregated requests are processed. The present invention implements interrupt coalescing in a data transfer environment, such as, for example, a DMA controller. The utilization of interrupt coalescing in a data transfer environment as described above allows to reduce the interrupt rate and to minimize processor time required to handle interrupt service routines. Furthermore, the cache hit rate may also increase since the interrupt service routine is being utilized for a number of data packets instead of one interrupt per packet.

As illustrated in the FIGURE, according to one embodiment of the present invention, the interrupt coalescing unit 124 may comprise a counter 126 and a timer 128. In specific, the counter 126 may be coupled to an interrupt pulse detector 130, which is coupled to a respective interrupt generation unit 114 of one of the ports 112, to sense generation of each interrupt request upon receipt of data packets at the respective port 112, one per packet. The pulse output of the interrupt pulse detector 130 operates to increment the count of the counter 126. The counter 126 is programmable to output an interrupt signal upon being incremented to a preselected, programmed number of interrupt requests. The count corresponds to an aggregation of interrupt requests. The output of the counter 126 is input to an or gate 132. The programmability of the number of interrupts to be accumulated prior to assertion of an interrupt to the CPU 118, provides a mechanism to optimize operation of the system. For example, an adaptive algorithm can be implemented to monitor system operation, and adjust the preselected number to achieve a best system performance level.

Moreover, the timer 124 is programmed to time out after a preselected, programmed time period after assertion of a first interrupt request by the interrupt generation unit 114. To that end, a flip-flop 134 includes an input coupled to the output of the interrupt pulse detector 130. A first interrupt pulse from the interrupt pulse detector 130 sets the flip-flop 132 to enable the timer 124. If the counter 126 reaches the preselected number before time out, an output of the counter 126 disables the timer 124, and resets the flip-flop 132. If not, the timer 124 times out, causing an output to be input to another input of the or gate 132.

Thus, either the counter 126 reaching a count equal to the preselected number of interrupt requests, or the timer 124 timing out, causes the or gate 132 to output an interrupt request to the interrupt control unit 122. In this manner, a number of interrupt requests are aggregated before the CPU 118 is interrupted.

In the preceding specification, specific exemplary embodiments and examples thereof have been described. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A computer system, comprising:
a CPU;
a DMA controller coupled to the CPU for transfer of data via a data transfer interrupt mechanism; and
an interrupt coalescing unit coupling the DMA controller to the CPU for aggregation of data transfer interrupts generated by the DMA controller, and transfer of data corresponding to the aggregated interrupts, between the CPU and the DMA controller, as a single interrupt.

2. The computer system of claim 1 wherein the interrupt coalescing unit aggregates data transfer interrupts until a preselected number of interrupts are aggregated.

3. The computer system of claim 2 wherein the interrupt coalescing unit initiates transfer of data corresponding to the aggregated interrupts upon time out of a preselected time period.

4. The computer system of claim 1 further comprising a peripheral device coupled to the DMA controller for transfer of data between the peripheral device and the CPU.

5. The computer system of claim 1 further comprising an interrupt control unit coupling the DMA controller to the CPU.

6. The computer system of claim 2 wherein the interrupt coalescing unit includes a counter to count aggregated data transfer interrupts.

7. The computer system of claim 3 wherein the interrupt coalescing unit includes a timer to time the preselected time period.

8. A method for transferring data between a DMA controller and a CPU, comprising the steps of:
aggregating data transfer interrupts generated by the DMA controller; and
controlling a transfer of data corresponding to the aggregated interrupts, between the CPU and the DMA controller, as a single interrupt.

9. The method of claim 8 wherein the step of aggregating data transfer interrupts generated by the DMA controller is carried out by aggregating data transfer interrupts until a preselected number of interrupts are aggregated.

10. The method of claim 9 wherein the preselected number of interrupts is programmable.

11. The method of claim 10 comprising the further step of monitoring system performance and programming the preselected number as a function of the monitoring.

12. The method of claim 9 wherein the step of controlling a transfer of data corresponding to the aggregated interrupts, between the CPU and the DMA controller, as a single interrupt is initiated upon time out of a preselected time period.

13. The method of claim 12 wherein the preselected time period is programmable.

14. For use in a computer system comprising a DMA controller coupled to a CPU, an interrupt coalescing unit arranged and configured for coupling the DMA controller to the CPU for aggregation of data transfer interrupts generated by the DMA controller, and transfer of data corresponding to the aggregated interrupts, between the CPU and the DMA controller, as a single interrupt.

15. The interrupt coalescing unit of claim 14 wherein the interrupt coalescing unit aggregates data transfer interrupts until a preselected number of interrupts are aggregated.

16. The interrupt coalescing unit of claim 15 wherein the interrupt coalescing unit initiates a transfer of data corresponding to the aggregated interrupts upon time out of a preselected time period.
